(19) United States
(12) Patent Application Publication
(10) Pub. No.: US 2019/0390819 A1
(43) Pub. Date: Dec. 26, 2019

(54) MULTIPOD WITH VARIABLE INDEPENDENTLY ANGULARLY ARTICULATING LOCKABLE LEGS AND MONOPOD TIP WITH CONCEALABLE STUD

(71) Applicant: Deep Blue Design, LLC, Cape Elizabeth, ME (US)

(72) Inventor: Stephen N. Underwood, Cape Elizabeth, ME (US)

(21) Appl. No.: 16/481,711

(22) PCT Filed: Jan. 30, 2018
(86) PCT No.: PCT/US18/16046

§ 371 Date: Jul. 29, 2019

Related U.S. Application Data
(60) Provisional application No. 62/451,983, filed on Jan. 30, 2017.

(51) Int. Cl. F16M 11/32; F16M 11/28; G03B 17/56

(52) U.S. Cl. CPC F16M 11/32; G03B 17/561; F16M 11/28

(57) ABSTRACT

A multipod and monopod apparatus are described. The multipod apparatus includes a plurality of legs forming a leg assembly wherein each leg assembly includes a yoke foot, a base including a leg lock plate coupled to the plurality of legs with a securing mechanism configured to apply pressure to the leg lock plate to secure each leg at a desirable angle. Each leg assembly includes washboard track, leg length adjuster saddle, adjuster lever and adjuster spring. An apparatus for securing a component to a monopod comprises a monopod flip tip assembly including cap section, base section and tether ring, wherein the cap section is coupled to the base section by the tether ring, wherein the cap section includes a tether ring groove for releasable engagement with the tether ring, and wherein the base section includes a port for engaging with the monopod and a stud for engaging with the component.

### BACKGROUND OF THE INVENTION

### 1. Field of the Invention

The present invention relates to maneuverable supports. More particularly, the present invention relates to multi-leg and single-leg supports that may be positioned in selectable locations. Still more particularly, the present invention relates to monopods, tripods and other multipods.

### 2. Description of the Prior Art

Originally, multipod support structures, such as tripods, were typically made with legs that splayed out symmetrically into a fixed position. If they were built to be extendable, the means for securing the telescoping legs was an arrangement of multiple twist collars, or some variation of flip-levers to lock the legs in a chosen position. The amount of time required to set up prior products with three, four or five twist collars per leg to their fully extended position and return them to the closed position often caused users to miss the unfolding action. In addition, twist locking legs tended to slip if not tightened adequately, or even if tightened substantially, the addition of liquids onto and into components allowed for slippage causing the tripod to become unstable and fall over, potentially damaging expensive equipment. Traditional tripods were also susceptible to upset since their center of gravity is typically high and they contained no means to secure them to objects, surfaces or substrates. Even with non-skid leg tips, they were vulnerable to unintended movement when bumped. Moreover, if the surface they were set upon was tilted, shifting or moving, the propensity for tipping was increased.

Nevertheless all of the multipod structures heretofore known suffer from a number of disadvantages. First, the angle of each leg when set up is typically the same, or limited to a few predetermined additional angles. Second, they cannot easily be secured to objects, surfaces or substrates at the foot point or other body locations. Third, they are not waterproof, weatherproof or rustproof Fourth, only one camera or accessory can be attached to the single mounting stud. Fifth, they require the twisting of three to sometimes fifteen collars to extend and retract them. Sixth, they are not a compact size when folded for storage. Seventh, the legs are not able to swing through a broad range of articulations independent of one another. Eighth, they are not user serviceable if a part is broken. A better multipod support structure is desirable.

Apart from multipods such as tripods, monopods are a popular camera accessory used to help stabilize a camera by screwing the camera onto a stud at the end of a pole, either of fixed length or telescoping style. The monopod pole is steadied by the user to support the weight of the camera and to reduce camera shake. The typical monopod design consists of a platform at the apex with a single protruding threaded stud, a pole of either fixed length or telescoping, and a bottom nub made of rubber or other material that rests on the ground, the floor, or other surface. The function of present monopod designs is limited by the sole threaded stud at the apex of the pole, which does not include a means of securing the opposite end of the pole to a multipod or tripod structure. A monopod design that secures the monopod to a camera on one end of the pole, and also secures the monopod to a multipod or tripod by means of a removable female-to-female adapter on the other end of the pole, is desirable to the user.

### SUMMARY OF THE INVENTION

Limitations of prior multipod configurations are overcome or alleviated by the present invention, which permits the angular position of attached legs to be set independently relative to one another through the application of pressure by a single central locking mechanism. According to an embodiment of the present invention, the multipod center support enclosure is formed of two interlocking half shells, and defining multiple pivotable receptacles providing connection to multiple multi-stage telescoping leg assemblies and a leg locking plate with a means of applying and releasing pressure to leg end pivot points. It is therefore one of the objects of the present invention to obviate the disadvantages of prior art multipods and their associated locking devices and to provide a multipod which can be deployed and folded without the user having to operate more than a single locking device. A second object of the present invention is to provide a multipod with two or more threaded studs and/or stud holes for the user to attach multiple cameras and/or accessories. A third object is to provide a multipod that is waterproof, weatherproof, and rustproof by designing and engineering the present invention with plastic and or metal parts that are exclusively waterproof and rustproof. A further object is to provide a multipod which has a low self-weight relative to its extended height and the weight of the supported load. The above-discussed and other features and advantages of the presently described multipod will be appreciated and understood by those skilled in the art from the following detailed description and drawings.

The present invention provides a multipod support structure, such as a tripod, which is made with a single central securing knob, legs which can be locked at a broad range of asymmetrical angles with pressure applied by a single knob and can be freed to extend and contract with a single press of a lever or button.

An embodiment of the multipod version of the invention includes a plurality of yoke feet that provide effective support for the legs of the multipod. For purposes of describing this version of the invention, a “yoke foot” means either a rotatable spoon foot or a pivotable swing foot. The spoon foot version pivots planarly with one degree of rotation. The swing foot version pivots rotationally with two degrees of rotation. It is to be understood that a plurality of either may be referred to herein as “yoke feet,” “spoon feet” and “swing feet” without deviating from the definition provided. The yoke feet, rotatable or pivotable stakes and multiple anchoring points at head, mid-section and foot locations allow the multipod to be secured to a variety of surfaces, substrates and objects.

The invention provides an apparatus with multiple variably pivoting, individually articulating, locking legs comprising a center support enclosure for supporting a load, provided with pivotable receptacles providing connection to at least three leg assemblies each accepted by said pivotable receptacles which are locked and unlocked via pressure from a leg locking plate provided with a means of applying and releasing pressure to the leg end pivot points. The apparatus as described with the addition of a leg length adjustment mechanism using an array of detent impressions or a track embedded into the leg, and an arm, tip, plug or other structure to permit or halt the extension at a given length. The apparatus as described with the addition of a yoke foot attached to the aforementioned leg. The apparatus as described with the addition of an articulating stake-shaped, talon-shaped, spike-shaped or similarly shaped tip. The apparatus as described with the addition of a single leg locking mechanism that locks three or more legs at angles independent of one another.

The present invention further provides an apparatus for supporting a component, the apparatus comprising a plurality of legs, each of the plurality of legs formed as a leg assembly wherein each leg assembly includes an upper leg section and a lower leg section, a base coupled to the upper leg sections of the plurality of legs and including a leg lock plate and a securing mechanism engaged with the leg lock plate of the base and configured to apply pressure to the leg lock plate so as to secure each of the plurality of legs at a desirable angle. The securing mechanism may be engaged with the leg lock plate through a rotatable shaft and wherein the securing mechanism is a threaded knob coupled to the rotatable shaft. The leg lock plate may engage the upper leg with interlocking gear teeth. The base may be a clamshell base formed of a top clamshell base and a bottom clamshell base. The geometry and structural shape of the clamshell base top and the clamshell base bottom are such that they provide one or more locations for the user to remove a bottle cap from a bottle. The clamshell base may form a pivotable receptacle for each of the plurality of legs. The upper leg section of each of the plurality of legs terminates in an axle configuration that is pivotable within the clamshell base. Each of the leg assemblies further includes an upper leg washboard track, a leg length adjuster collar, a length adjuster tab, a leg length adjuster pin and a leg length adjuster spring. Each of the upper leg washboard tracks includes a plurality of depressions and wherein the leg assemblies are operated by depressing the tab to disengage the tab from the upper leg washboard track allowing for lower leg length adjustment and releasing the tab into a selectable one of the washboard track depression to secure the leg in a chosen position. The upper leg washboard track may be formed by any of a series of detents, raised ridges or protrusions. In an alternate embodiment, the leg length adjuster collar is replaced by a leg length adjuster saddle which is contained within the geometry of the lower leg. It is noted that each lower leg section of each leg assembly may include a yoke foot. Each such yoke foot may be coupled to the lower leg with a yoke foot pivot assembly that is configured to allow the yoke foot to be pivoted to various angles. The apparatus may include a pivot stake coupled to each yoke foot. The pivot stake may be a triangular spike with an elongated teardrop slot. Alternatively, the pivot stake may be a triangular spike or other shaped spike with an elongated teardrop slot and a plurality of retaining ports, or, in another embodiment, contain no slots, holes or ports of any kind. The plurality of retaining ports includes one or more threaded ports and one or more unthreaded ports.

The present invention also replaces the bottom nub of a typical monopod with a flip tip assembly that includes a tethered cap and cap base. The tethered cap, when removed, exposes a male stud as a means to attach a camera or camera accessory. The flip tip assembly cap of the present invention is attached to the monopod via a cord, strap or tether for safe keeping and to prevent loss of the flip tip assembly cap. The flip tip cap tether may terminate in a tether ring which interlocks with the cap base via a groove around the circumference of the cap base. The fit between the tether ring and the cap base groove is loose enough to allow the tether ring to be rotated freely when engaging and disengaging the flip tip cap and tight enough to hold the tether ring securely within the cap base groove. One or more holes are also provided around the sides of the flip tip assembly base to allow for the passage of string, cord, line, elastic, bungee or other materials to be threaded through the hole(s) and tied off to stabilize the monopod more securely when desired.

This form of the invention may be characterized as an apparatus for securing a camera, camera accessory, or other component to a monopod, the apparatus comprising a monopod flip tip assembly including a cap section and a base section and a concealable stud, wherein the cap section includes a tip cap hingedly connected to a cap body and arranged to conceal the stud therein. The flip tip assembly cap may be configured to attach to the flip tip assembly base by means of, but not limited to, a threaded fastener connection or frictional fit insertion. The flip tip assembly base section may further include one or more portals configured to allow for the passage of string, line, rope, elastic, bungee and other flexible materials to secure the monopod flip tip assembly base to the monopod or other structure. An underside of the flip tip assembly cap section includes engagement wedges arranged for fastener connection or frictional fitting into cavities of the flip tip assembly base section when the two sections are pressed together.

Accordingly numerous advantages of one or more aspects of the present invention are as follows: to provide multipods that are extremely versatile in their height setup, angular setup, orientation setup, and extension setup variations, that can be locked in place with the use of a single central locking knob and leg extension levers, that can be secured by staking into various materials and substrates, that can be hung off and attached to various objects, structures and surfaces, that can be anchored at multiple securing points using rope, line, string, bungee, tie wraps, duct tape, that is constructed of fully waterproof materials, that can accommodate more than one camera or accessory at a time, that is lightweight, that is compact when folded for storage, and that is user serviceable. Other advantages of one or more aspects of the multipod of the present invention will be apparent from a consideration of the drawings, ensuing description and associated claims. These and other features and advantages of the invention may be seen in review of the accompanying drawings, detailed description and appended claims.

### BRIEF DESCRIPTION OF THE DRAWINGS

FIG. 1A is a side view of an example multipod in the form of a tripod in the closed position according to some embodiments of the present invention.

FIG. 1B is a side view in an open position and all legs extended to maximum length according to some embodiments of the present invention.

FIG. 2 is a top perspective view of the center support enclosure according to some embodiments of the present invention.

FIG. 3A is a bottom perspective view of the center support enclosure with legs folded upward according to some embodiments of the present invention.

FIG. 3B is a sectional plan view of the center support enclosure according to some embodiments of the present invention.

FIG. 4A is a close up of the leg length adjustment mechanism according to some embodiments of the present invention.

FIG. 4B is a sectional plan view of the leg length adjustment mechanism according to some embodiments of the present invention.

FIG. 5A is a perspective view of the leg tip, pivoting spoon foot and pivoting stake in closed position according to some embodiments of the present invention.

FIG. 5B is a perspective view of the leg tip with pivoting spoon foot rotated according to some embodiments of the present invention.

FIG. 5C is a perspective view of an alternative pivoting stake of the present invention.

FIG. 5D is a top view of the alternative pivoting stake of FIG. 5C.

FIG. 5E is a side view of the alternative pivoting stake of FIG. 5C.

FIG. 6 is a side view of the tripod of FIG. 1A in an alternate closed position according to some embodiments of the present invention.

FIG. 7 is a perspective view of a monopod tip assembly of the present invention with the cover flipped out 180° and the threaded stud exposed.

FIG. 8 is a perspective view of the monopod tip assembly with the cover closed and the threaded stud hidden.

FIG. 9 is a perspective exploded view of the monopod flexible hinged cover and the monopod tip base.

FIG. 10 a perspective view of the underside of the monopod tip base with the hinged cover flipped out 180°.

FIG. 11 is side view of the monopod tip base with the flexible cover flipped out 180°.

FIG. 12 is side view of the monopod tip base with the flexible cover fitted over the top of the mounting stud.

FIG. 13 is a perspective exploded view showing the attachment protrusions of the flexible cover which mates with the monopod tip base.

FIG. 14 is a side view of an alternate swing foot assembly according to some embodiments of the present invention.

FIG. 15 is a sectional elevation view of an alternate swing foot assembly according to some embodiments of the present invention.

FIG. 16 is an exploded view of an alternate swing foot assembly according to some embodiments of the present invention.

FIG. 17. is a perspective exploded view of an alternate leg length adjustment mechanism according to some embodiments of the present invention.

FIG. 18. is a perspective view of an embodiment of the center support enclosure with the inclusion of a bottle opener.

FIG. 19. is a perspective view of an alternate monopod tip assembly of the present invention with the cover flipped out 180° and the stud exposed.

FIG. 20. is a side view of the alternate monopod tip assembly of the present invention with the cover flipped out 180° and the stud exposed.

FIG. 21. comprises multiple views of the base section of the alternate monopod tip assembly of the present invention.

FIG. 22 is a plan view of the alternate monopod tip assembly with the cap separated from the base.

FIG. 23 is side view and bottom view of the cap of the alternate monopod tip assembly.

FIG. 24 comprises multiple views of a female-to-female coupler of the present invention.

### DETAILED DESCRIPTION OF THE INVENTION

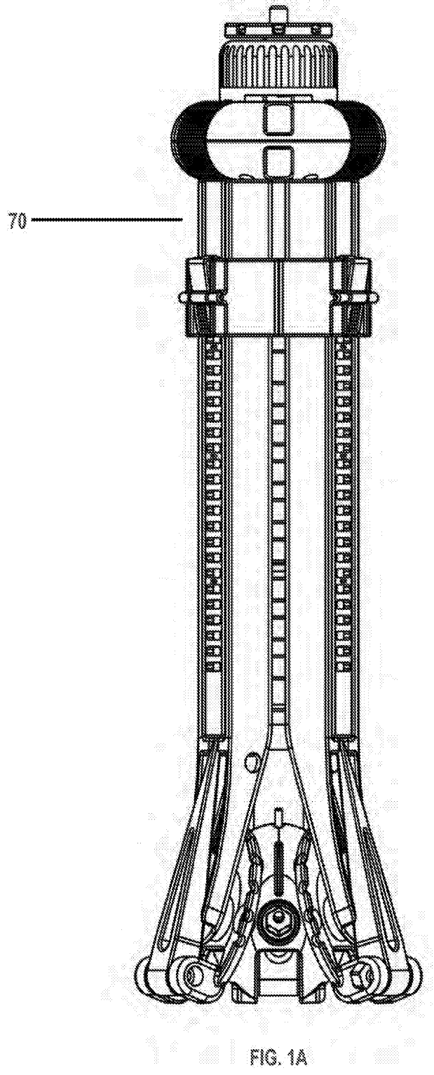

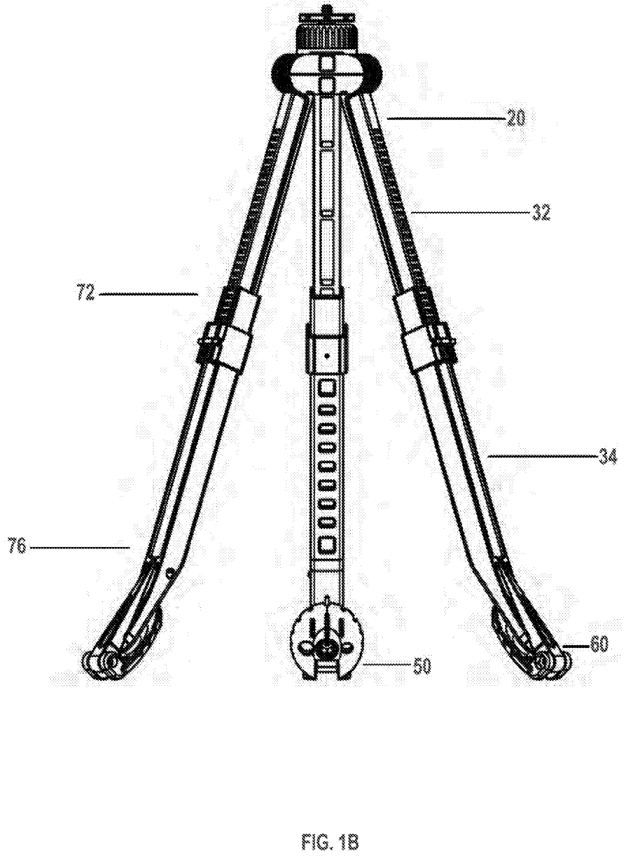

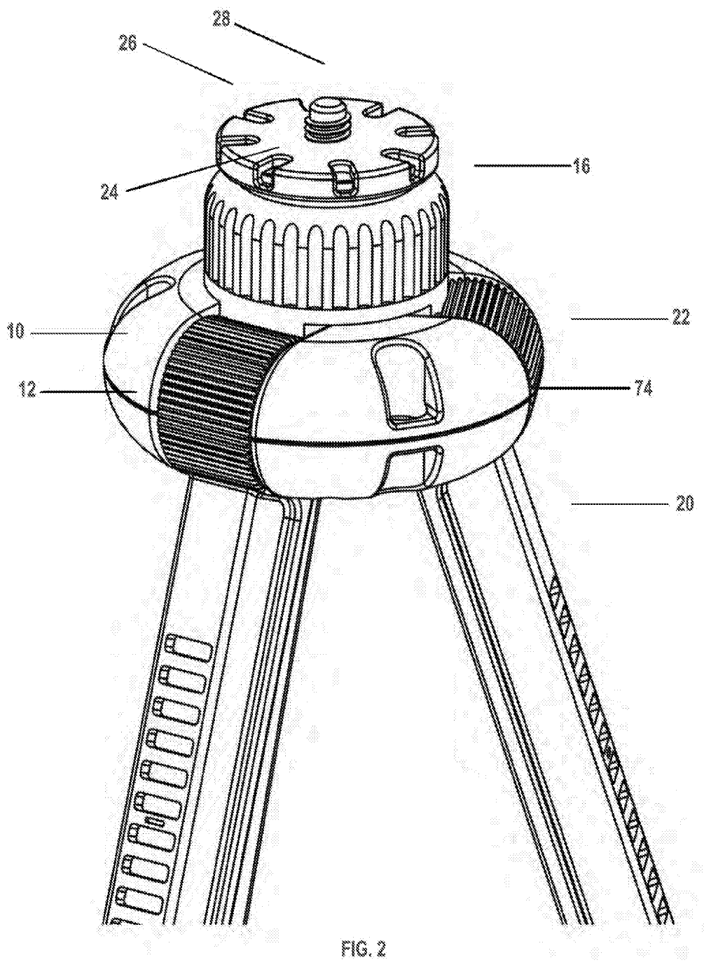

Referring to FIGS. 1B, 2 and 3B, a multipod structure in the form of a tripod 70 in accordance with the present invention is shown and includes a clamshell base 74, a platform disk 24, a multi-threaded shaft 14 with mounting stud 28, a leg lock plate 18, a securing mechanism 16, and a plurality of legs 72. In the example described herein, the tripod 70 has such legs 72. It is to be understood that the leg configurations described herein may be used with a support structure that has two or more legs, not limited to three. The clamshell base 74 has two half shells, top clamshell base 10 and bottom clamshell base 12, connected with fasteners which, when assembled, forms a pivotable receptacle for the tripod legs 72. An upper leg section 20 of each of the legs 72 terminates in an axle configuration that pivots within the pivotable receptacle of the clamshell base 74.

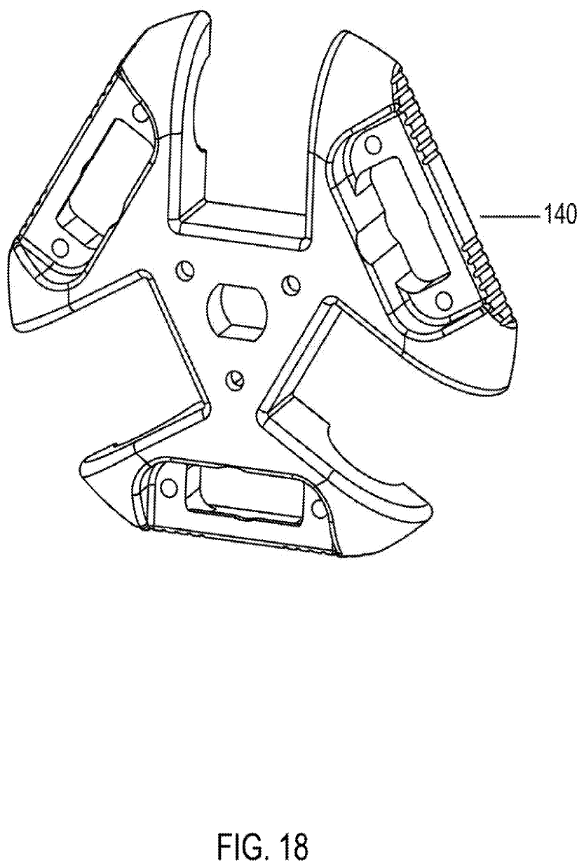

The securing mechanism 16, which may be threaded, applies pressure to the leg lock plate 18 and locks each leg 72 at a desired angle. The securing mechanism 16 includes a threaded knob coupled to the multi-threaded shaft 14 but other means of applying pressure may be used including cam locks, screws or other methods. In one embodiment, the leg lock plate 18 is made of ABS plastic, but aluminum, steel or other materials may be used. The leg lock plate 18 contacts the upper leg 20 using interlocking gear teeth, but knurled surfaces, roughened surfaces, tacky rubber surfaces or other friction generating materials and methods may be used. Other components of the present invention such as, for example, the pivot plate 60, also may be formed of various materials including those used to make the leg lock plate 18. The geometry and structural shape of the clamshell base top 10 and the clamshell base bottom 12 may be configured to include one or more bottle opener arrangements 140 as shown in FIG. 18 for the user to remove a bottle cap from a bottle.

The leg assembly 76 includes the upper leg section 20 and a lower leg section 34, a leg length adjuster collar 38, a length adjuster tab 40, leg length adjuster pin 42 and leg length adjuster spring 44. Depressing the tab 40, disengages the tab 40 from upper leg washboard track 32 allowing lower leg length adjustment. Releasing the tab 40 into any washboard track depression secures the leg in the new chosen position. The track 32 may be formed of a series of detents, raised ridges, protrusions or other shapes may be used.

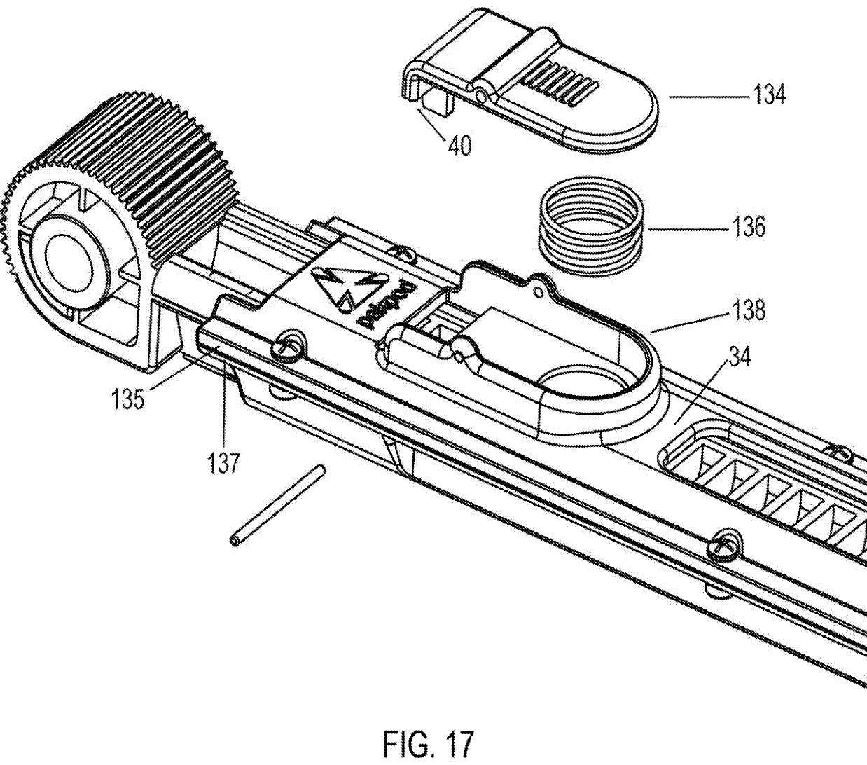

In an alternate embodiment of the lower leg section 34 as shown in FIG. 17, the leg length adjuster collar 38 is replaced by a leg length adjuster saddle 138, which forms part of the lower leg section 34. The lower leg section 34 configured to use the saddle 138 includes a top body 135 and a bottom body 137 that are joined together. The bottom body is configured to enable the track 32 to move therein. The top body 135 is configured to contain the leg length adjuster saddle 138. A leg length adjuster spring 136 of the saddle 138 applies a force upon leg length adjuster lever 134 to keep tab 40 engaged with the track 32 where selectably positioned. The leg length adjuster saddle 138 may be used to move the lower leg section 34 with respect to the upper leg section 20 so that the track 32 is substantially hidden from view when the legs are retracted. The top body 135 may be concave shaped as shown or otherwise configured to engage with the leg length adjuster saddle 138. The tab 40 is disengaged from the track 32 when the leg length adjuster lever 134 is actuated. The length of the lower leg section 34 can be smoothly changed to a desired position with respect to the upper leg section 120 and then the lever 134 released to re-engage the tab 40 with the track 32. The upper leg section 20 may be modified to include rails that engage with the top body 135 and the bottom body 137 of the lower leg section 34 to facilitate movement of the lower leg section 34 on the upper leg section 20.

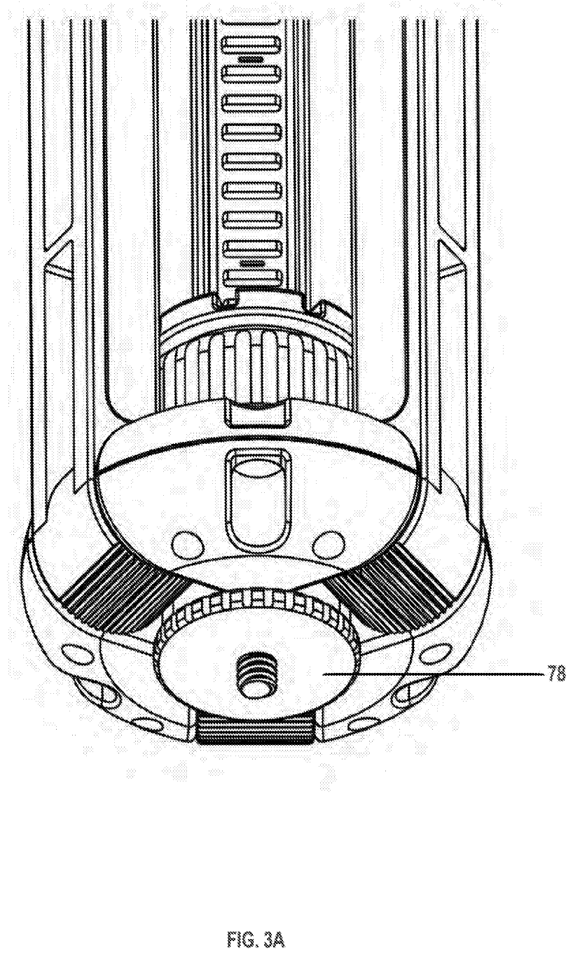

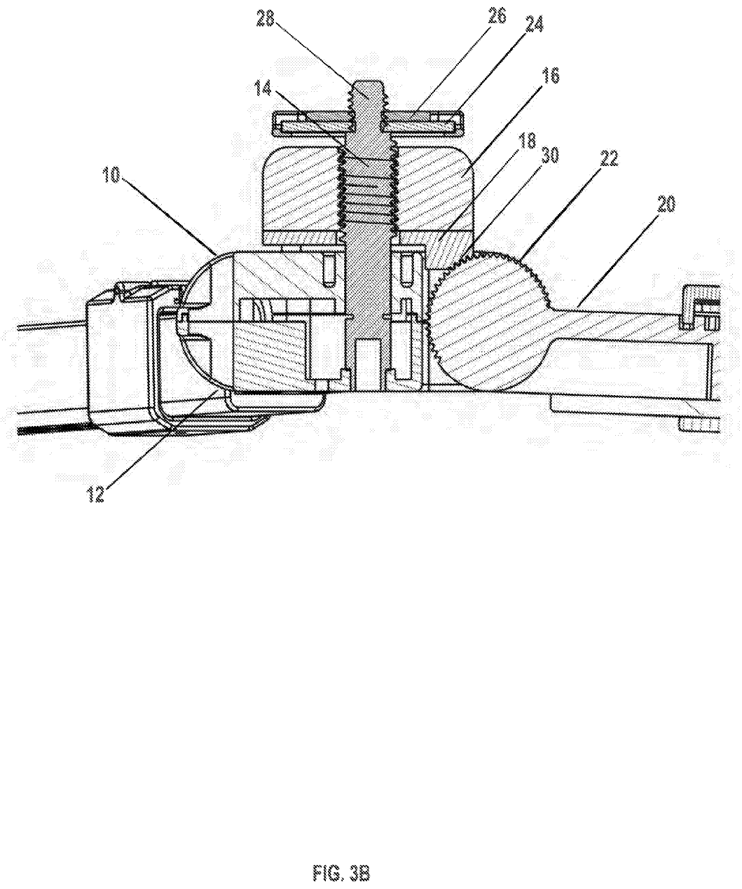

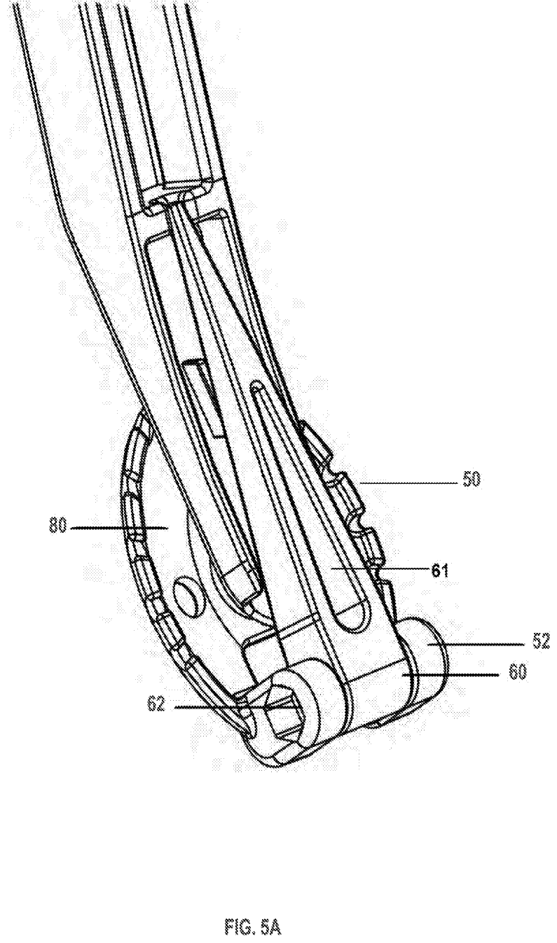

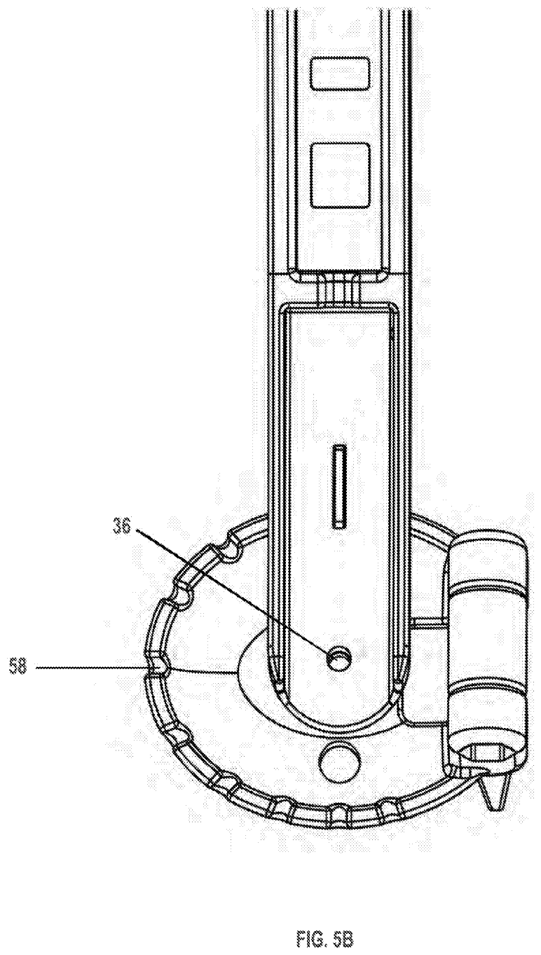

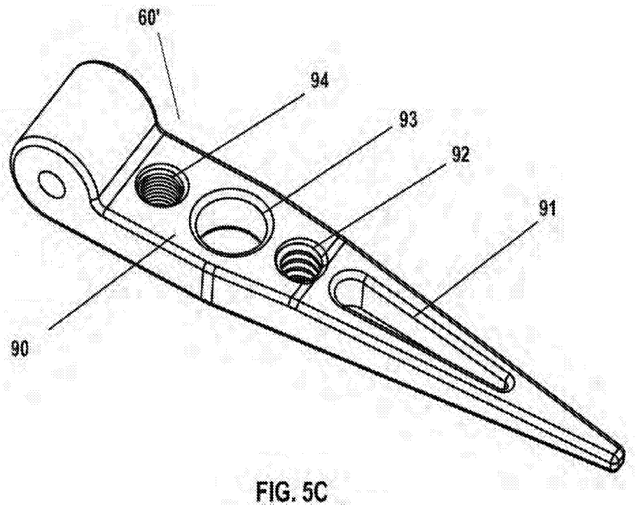

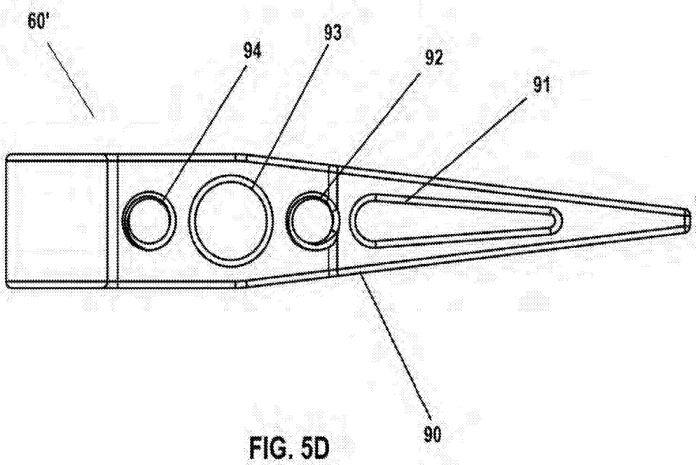

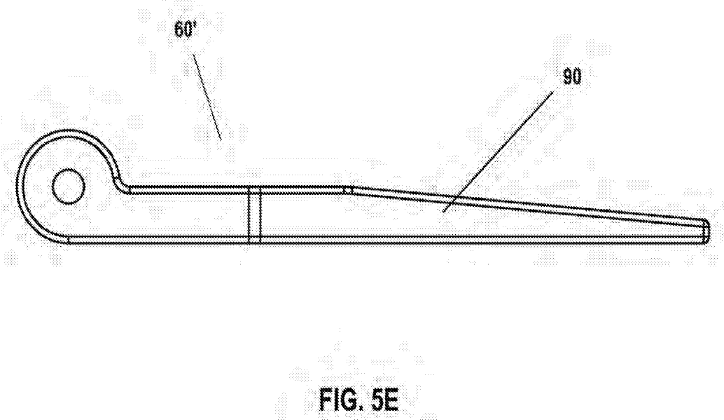

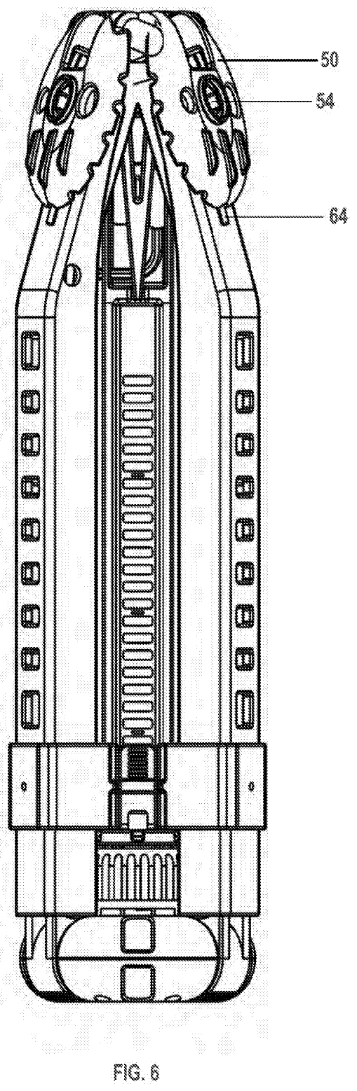

FIGS. 5A, 5B and 6 illustrate a spoon foot assembly 80 of the tripod 70. Spoon foot 50 is coupled to lower leg 34 with a spoon foot pivot assembly that may be, for example, a bolt and nut combination with one or more washers, at a tightness amount that allows the spoon 50 to be pivoted to various angles. Detents 58 on spoon perimeter allow for locking of the spoon at various rotational angles when a detent encounters the detent spur 64. Pivoting stake 60 is fastened to spoon foot yoke 52 with a pivoting stake fastener assembly that may be, for example, a bolt and nut combination with one or more washers, tightened to an amount that allows the stake to be rotated and set at various positions. In one embodiment, the stake is made of a nonmetallic material such as a plastic including ABS plastic, for example. Other materials such as metallic materials such Aluminum, steel or other materials may be used. A secondary mounting stud 78 shown in FIG. 3B, allows for the attachment of a second camera or accessory.

FIGS. 1A, 1B, 5A and 6 show the pivoting stake 60 as a triangular spike with an elongated teardrop slot 61 extending a substantial portion of the stake body. An alternative embodiment of the pivoting stake 60′ is shown in FIGS. 5C-5D, in which a body 90 of the stake 60′ includes a smaller elongated teardrop slot 91, as well as retaining ports 92-94, of which one or more may be threaded as represented by ports 92 and 94, or one or more may be unthreaded as represented by port 93. The alternative pivoting stake 60 may be used to secure the tripod 70 to a substrate, such as by screwing it using one or more threaded ports as an interface, or by bolting or other means through one or more unthreaded ports. One or more of the legs 72 may include the alternative pivoting stake 60′.

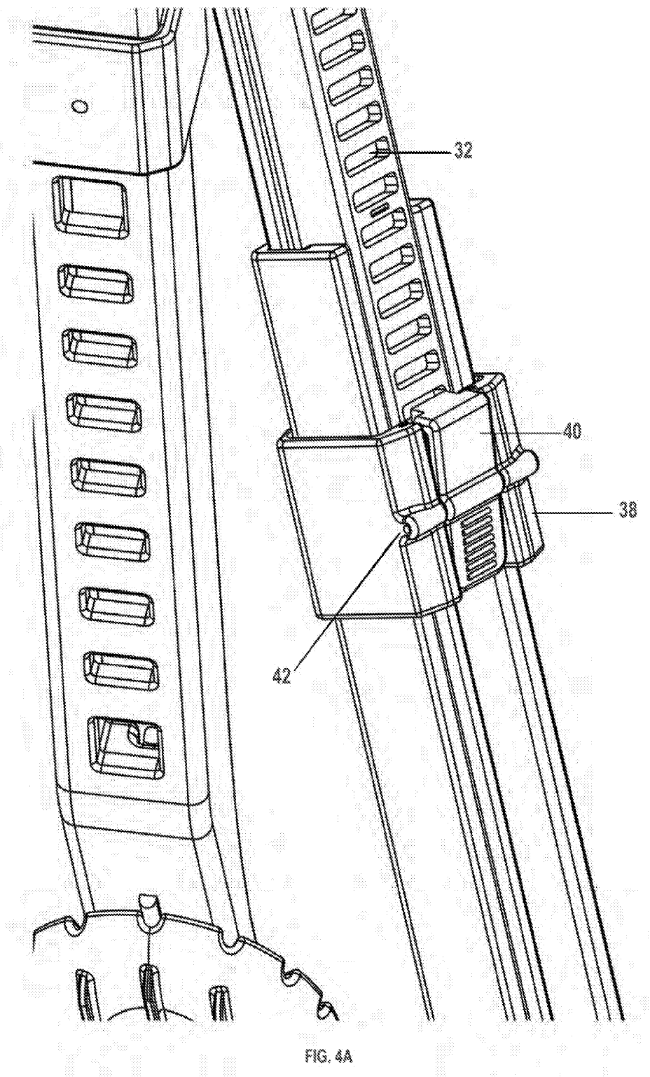

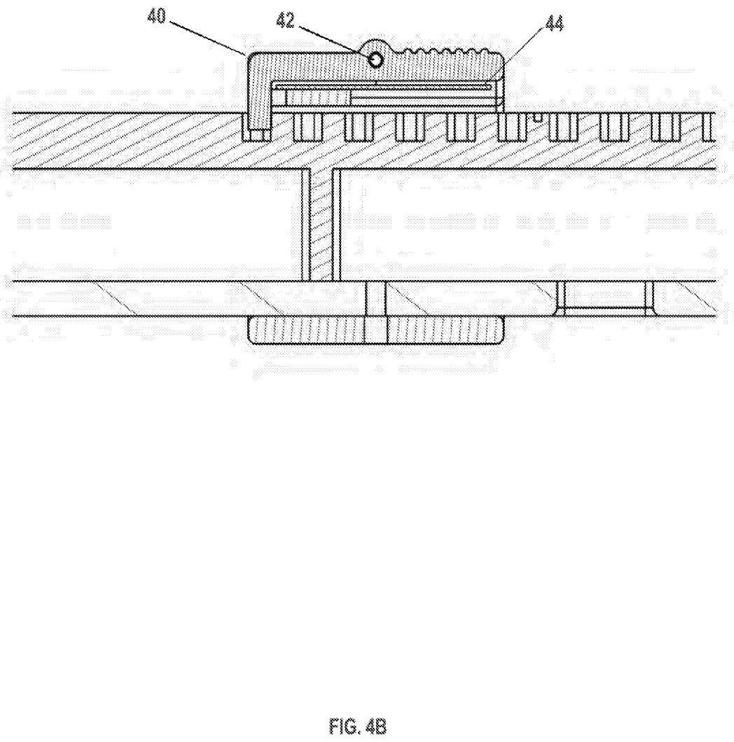

The matter of using the multipod of the present invention starting in a closed configuration as closed tripod 70 in FIG. 1A to support one or two cameras or accessories, is initiated by loosening the securing mechanism 16 (FIG. 3B), which allows the tripod leg assemblies 76 (FIG. 1B) to swing freely away from each other and placed in the desired position at angles independent of one another. The securing mechanism 16 is then tightened which engages the interlocking gear teeth 30 and 22, (FIG. 3B) or knurled or rough or rubber surfaces at the point of contact. Next, the leg length rocker tab 40 (FIG. 4A) is grasped with thumb and fore finger and pressed, disengaging rocker tab 40 from track 32 or detents, raised ridges, protrusions or other repeated shapes. This flexes the leg length adjuster spring 44 or rubber bumper or another spring-like device. The lower leg 34 is then extended to the desired length. The rocker tab 40 is then released and the spring 44 returns the rocker tab to the engaged position inside the selected detent, raised ridge, protrusion or other repeated shape. The spoon foot 50 (FIG. 5A) may be pivoted by slightly flexing the spoon foot material to disengage spoon foot 50 detent 58 from the detent spur 64 (FIG. 6).

After pivoting the spoon foot 50 to the desired detent 58 position, the spoon foot detent 58 is mated to the detent spur 64. The pivoting stake 60 (FIG. 5A) which is connected to the spoon foot yoke 52 with the spoon foot fastener assembly 56 may be tightened or loosened with a hex head wrench to produce the desired amount of pivot friction. Rotating the pivoting stake 60 to the desired angle is achieved by grasping the pivoting stake 60 and pulling it away from the spoon foot assembly 80 and releasing it at the desired angle. The tripod 70 may be closed in an alternate configuration (FIG. 6) by rotating the three or more tripod leg assemblies 76 to the point where the respective spoon foot yokes 52 make contact. The securing mechanism may then be tightened which engages the interlocking gear teeth 30 and 22, (FIG. 3B) or knurled or rough or rubber surfaces at the point of contact. Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

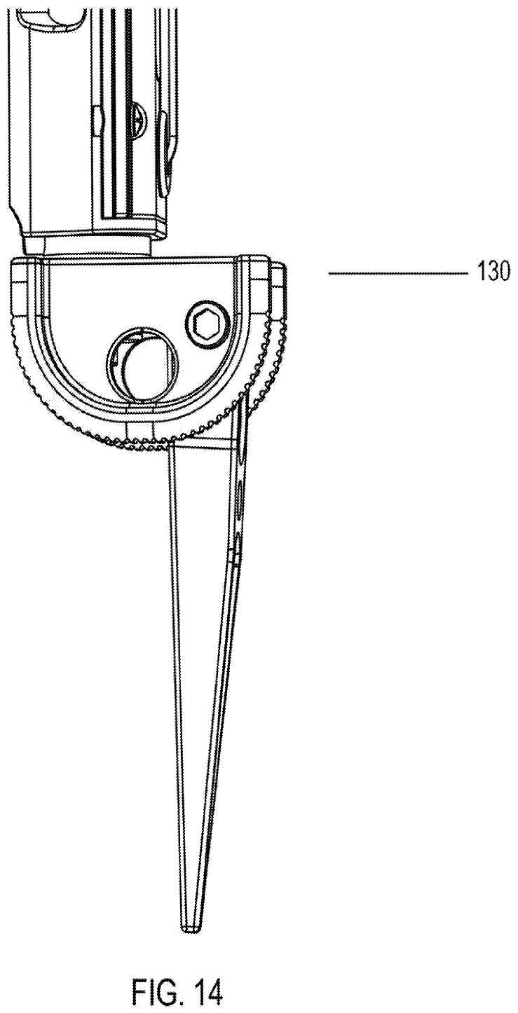

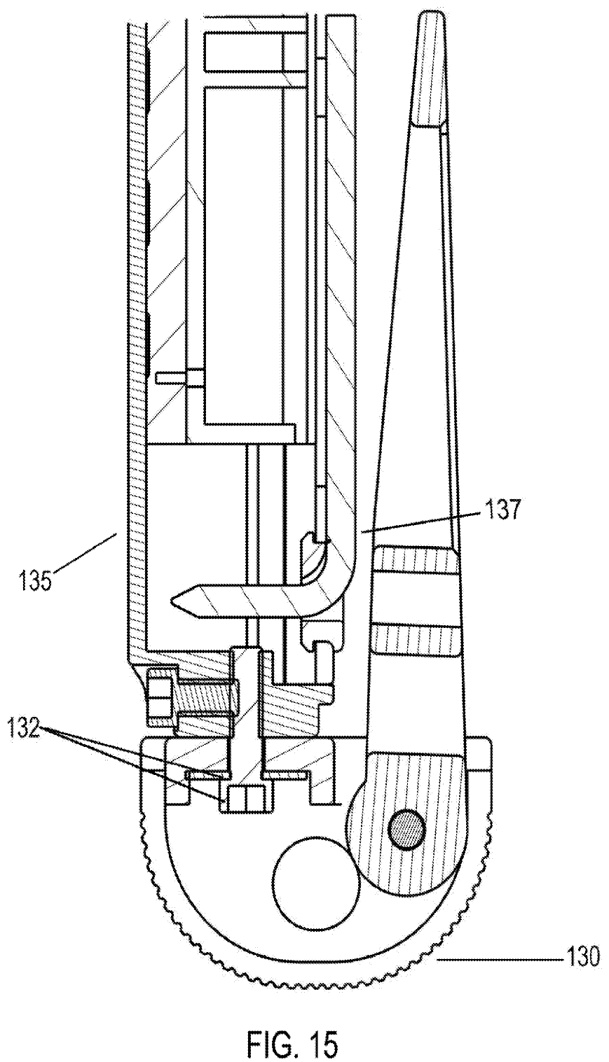

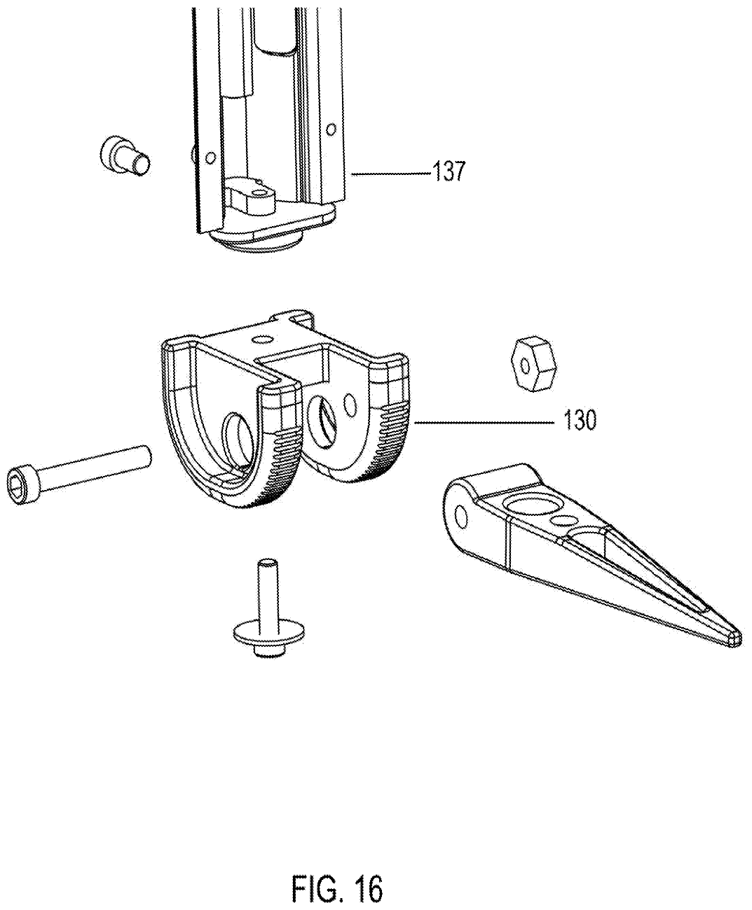

FIGS. 14, 15 and 16 illustrate an alternative swing foot 130 of the tripod 70. Swing foot 130 is coupled to lower leg 34 with a swing foot pivot assembly 132 that may be, for example, a bolt and nut combination with one or more washers, at a tightness amount that allows the swing foot 130 to be moved with two degrees of rotation. In one embodiment, the swing foot 130 is made of rubber material, but plastic, steel or other materials may be used. The swing foot pivot assembly 132 may be tightened or loosened with a hex head wrench (or other adjusting tool) to produce the desired amount of rotational friction. Pivoting stake 60 is fastened to swing foot 130 with a pivoting stake fastener assembly that may be, for example, a bolt and nut combination with one or more washers, tightened to an amount that allows the stake to be moved through two degrees of rotation and set at various positions. In one embodiment, the stake 160 is made of a nonmetallic material such as a plastic including ABS plastic, for example. Other materials include metallic materials such as, without limitation, aluminum, steel or other metallic materials.

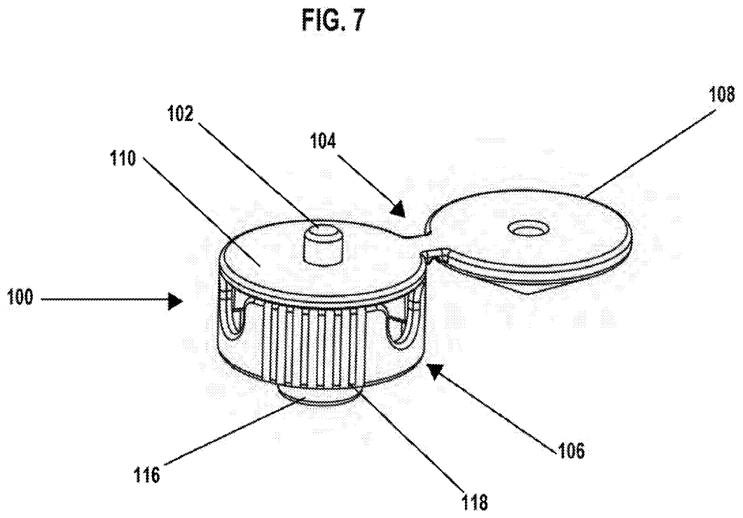

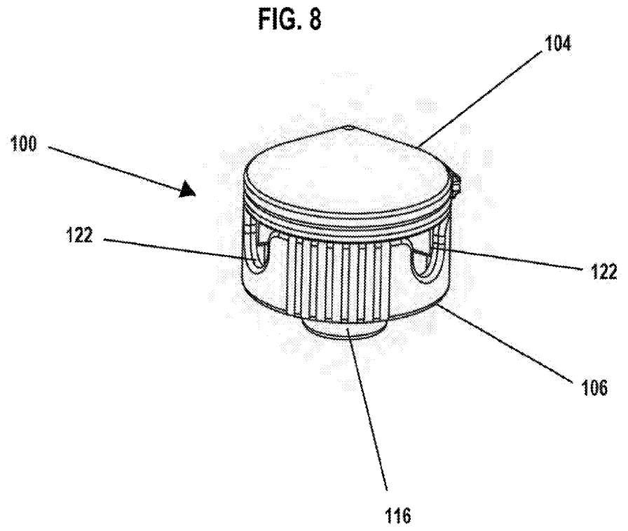

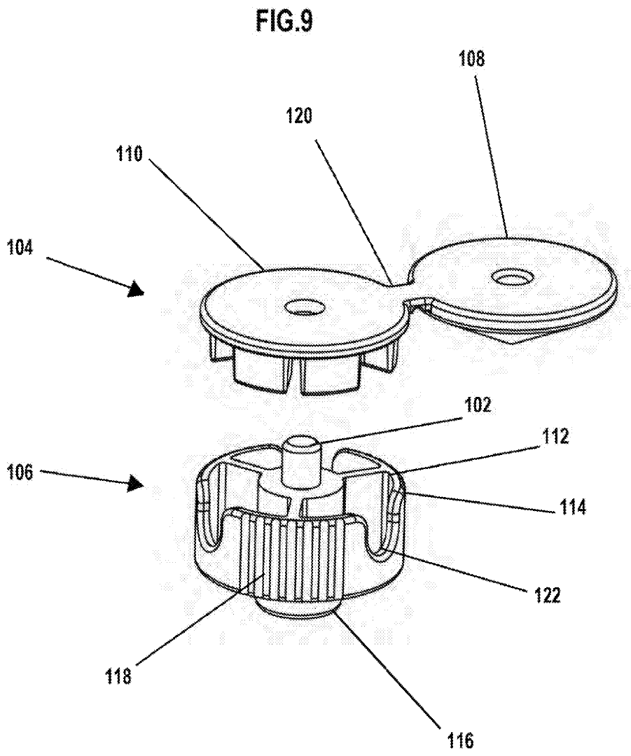

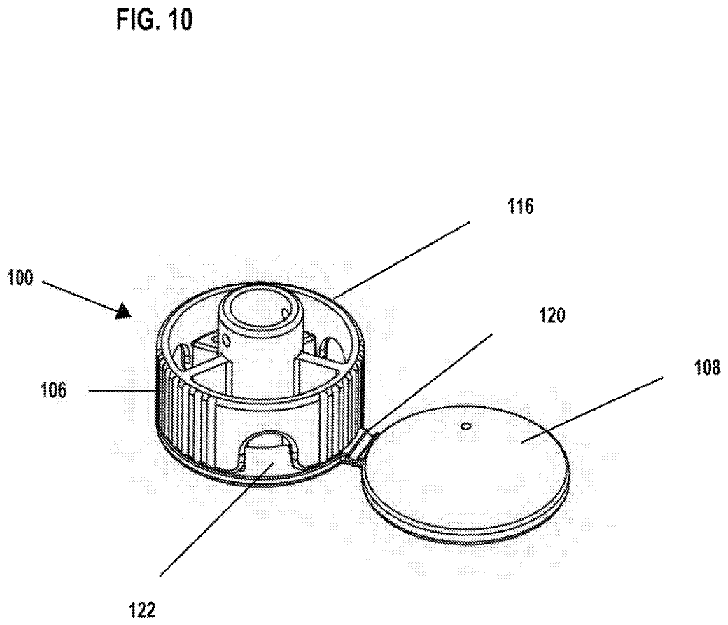

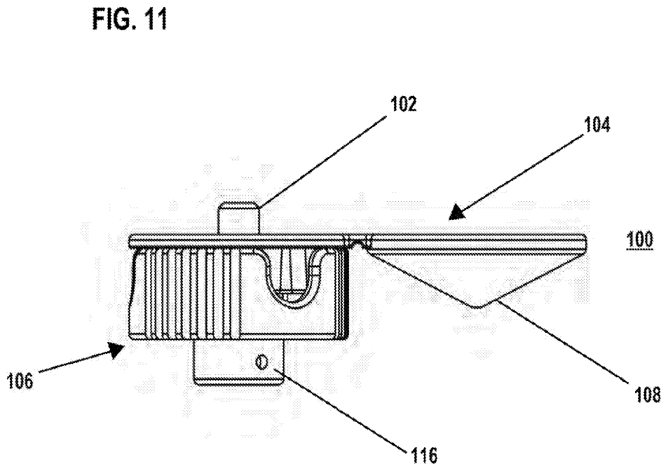

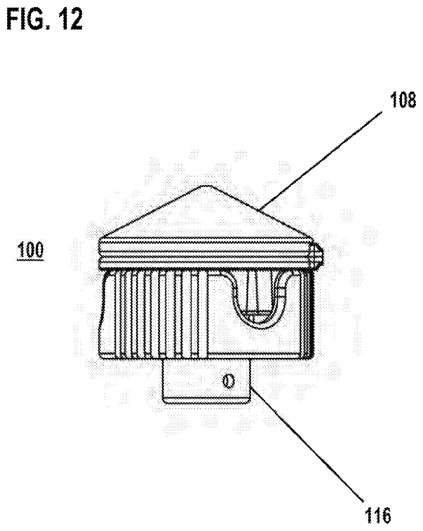

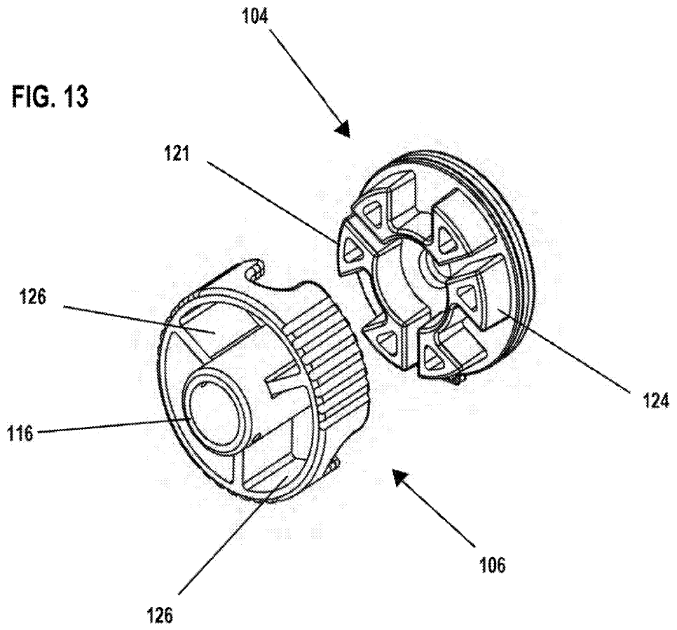

The present invention in the form of a monopod tip 100 with concealable stud 102 is shown in FIGS. 7-13. The tip 100 includes a cap section 104 and a base section 106. The cap 104 includes a tip cap 108 hingedly connected to cap body 110. FIG. 7 shows the monopod tip 100 with the cap flipped off and away to reveal the concealable stud 102. FIG. 8 shows the monopod tip 100 with the tip cap 108 secured so that the tip cap 108 covers the stud 102. FIG. 9 shows the cap section 104 removed from the base section 106. The tip cap 108 is hingedly connected to the cap body 110 so that it is tethered to the cap body 110, such as with a pliable or flexible material such as a thin and/or soft plastic material in the form of anchor interface 120. FIG. 10 shows a base portal 122, of which there may be one or more around the perimeter of the base section 106. The base portals 122 are configured to allow for the passage of string, line, rope, elastic, bungee and other flexible materials to secure the monopod tip 102 to the monopod when deployed on the monopod. FIG. 11 is a side view of the monopod tip 100 with the tip cap 108 flipped out 180°. FIG. 12 is a side view of the tip cap 108 secured to the stud 102. FIG. 13 is an exploded view of the underside of the cap section 104 and the base section 106. The underside of the cap section 104 includes engagement wedges 124 arranged for frictional fitting into cavities 126 of the base section 106 when the two sections are pressed together during assembly. Other mechanisms for permanently or removably securing the cap section 104 and the base section 106 together are possible.

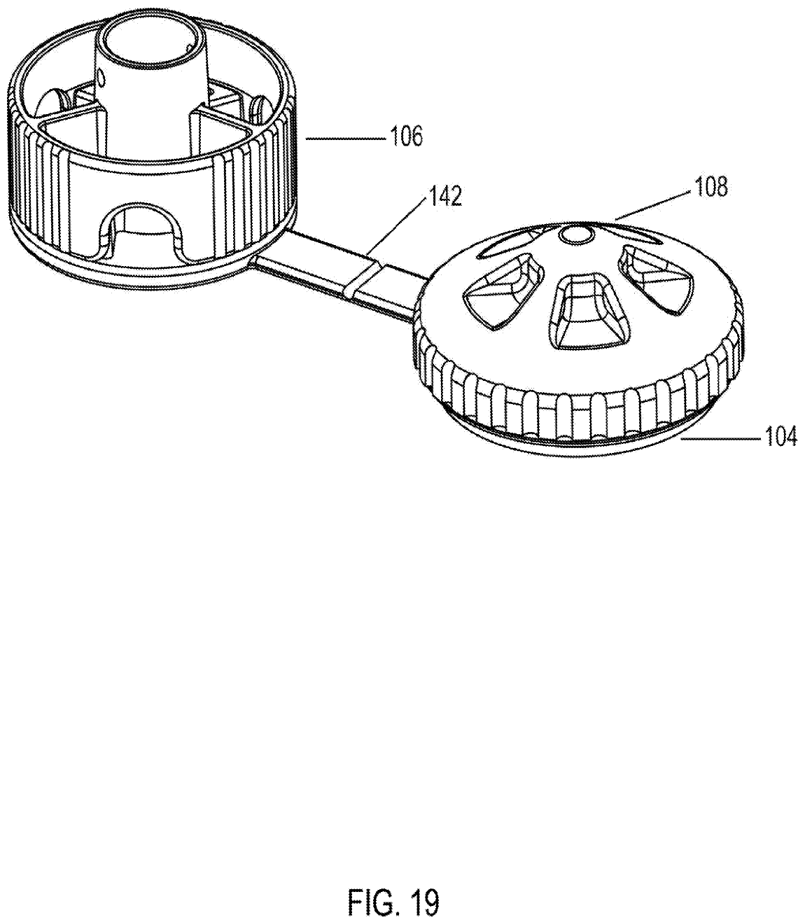

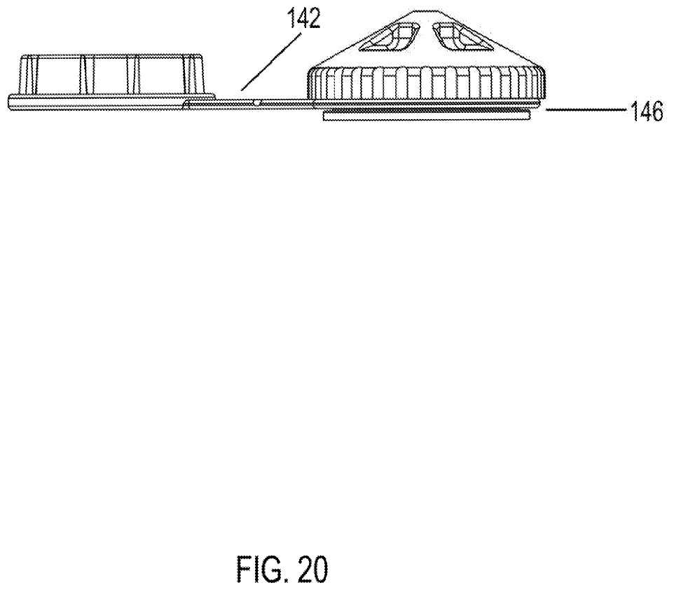

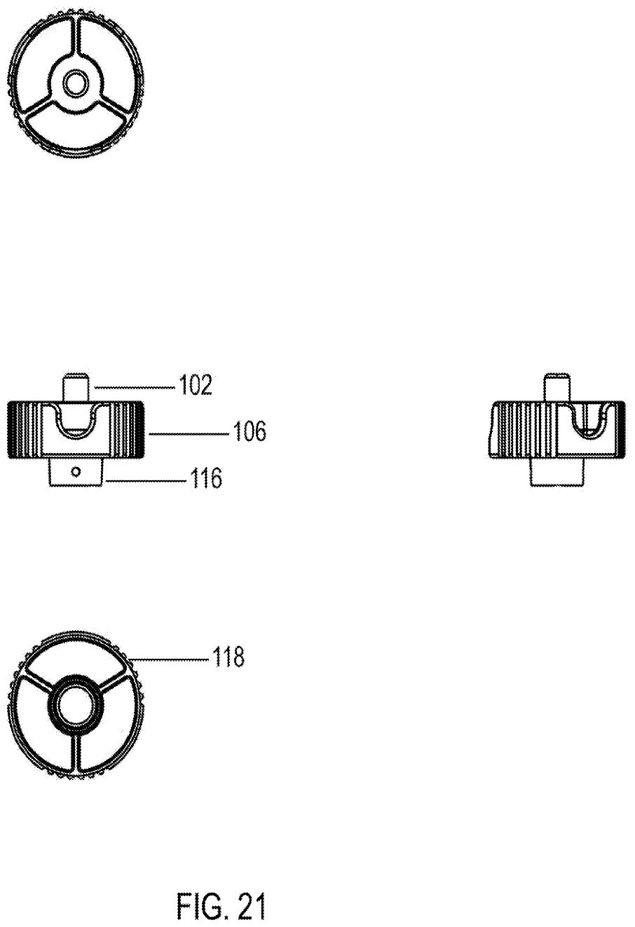

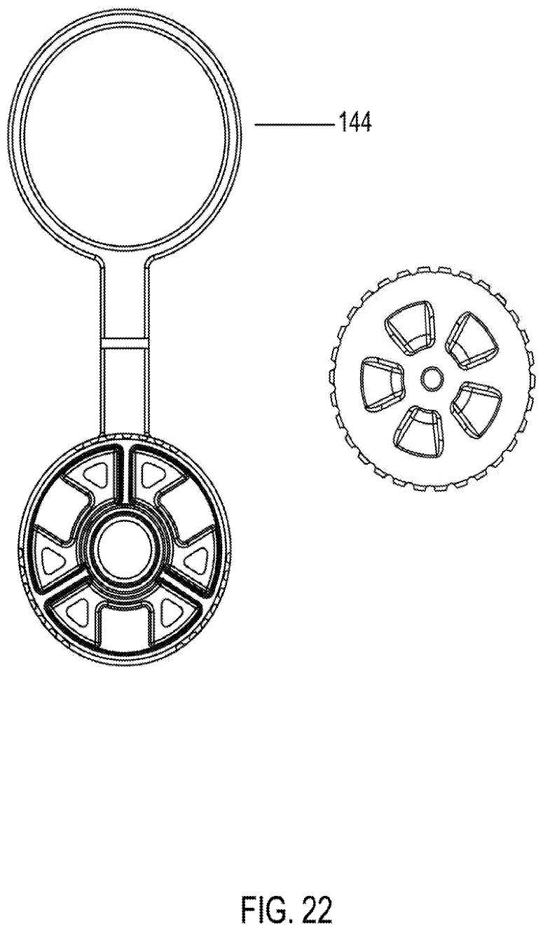

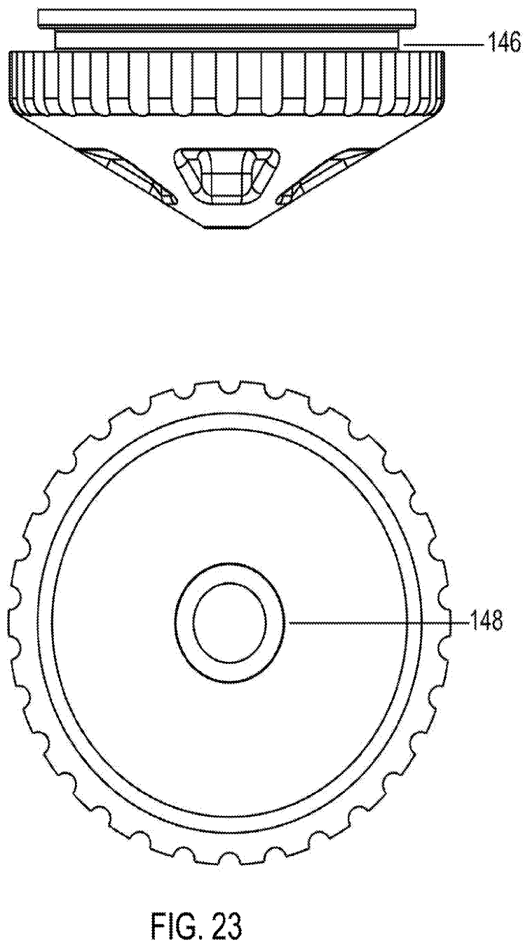

An alternative version of the monopod tip assembly 108 shown in FIGS. 19-23, may be configured to attach to the base section 106 by means of, but not limited to, a threaded fastener connection 148 or frictional fit insertion. The tip cap section 104 tether 142 may terminate in a tether ring 144 which interlocks with the cap body 110 via a tether ring groove 146 around the circumference of the cap body 110. The fit between the tether ring 144 and the tether ring groove 146 is loose enough to allow the tether ring 144 to be rotated freely when screwing and unscrewing the cap section 104 and tight enough to hold the tether ring 144 securely within the tether ring groove 146. The cap body 110 is configured for frictional fit insertion into an interior 112 of a top side 114 of the base 106. The cap 104 may be disengaged from the base 106 in this configuration. That may be desirable if the cap 104 is to be replaced or a connector other than the concealable stud 102 is to be used on the monopod. The base 106 includes a bottom side stud 116 arranged for removable engagement with a top surface of the monopod; however, other ways for engaging the base 106 with the monopod are possible. An exterior surface 118 of the base 106 may be knurled to allow for ease of rotation of the tip 100 on the monopod, or removal of the tip 100 from the monopod.

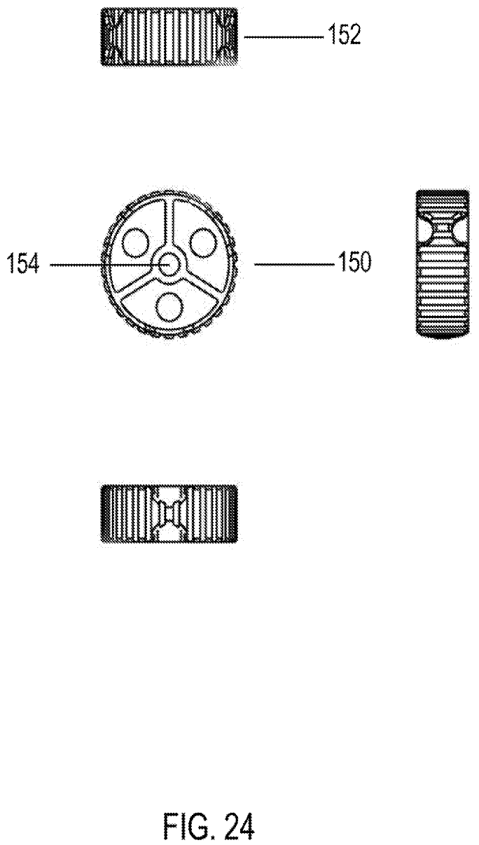

FIG. 24 shows an optional female-to-female adapter 150 that can be used to secure together a plurality of monopods and/or multipods. The adapter 150 is engaged with the stud(s) on a typical monopod or multipod structure. The adapter 150 may, for example, be used in conjunction with the stud 102 of assembly 108. The adapter 150 is formed with a body 152 and opposing ports 154 for receiving and engaging the studs. The adapter 150 may be effectively utilized as a means by which to extend the reach of any multipod or tripod structure.

While example embodiments of the present invention have been shown and described, it will be understood that various modifications and changes could be made thereunto without departing from the spirit and scope of the invention as defined by the following claims.

What is claimed is:

1. An apparatus for supporting a component, the apparatus comprising:
a. a plurality of legs, each of the plurality of legs formed as a leg assembly wherein each leg assembly includes an upper leg section and a lower leg section, wherein each lower leg section includes a yoke foot;
b. a base coupled to the upper leg sections of the plurality of legs and including a leg lock plate; and
c. a securing mechanism engaged with the leg lock plate of the base and configured to apply pressure to the leg lock plate so as to secure each of the plurality of legs at a desirable angle.

2. The apparatus of claim 1, wherein the yoke foot is a swing foot.

3. The apparatus of claim 2, wherein each swing foot is formed with a swing foot pivot assembly coupled to the lower leg in a way that allows the swing foot to be moved with two degrees of rotation.

4. An apparatus for supporting a component, the apparatus comprising:
a. a plurality of legs, each of the plurality of legs formed as a leg assembly wherein each leg assembly includes an upper leg section, a lower leg section; wherein each leg assembly includes an upper leg washboard track, a leg length adjuster saddle, a length adjuster tab, a leg length adjuster lever and a leg length adjuster spring;
b. a base coupled to the upper leg sections of the plurality of legs and including a leg lock plate; and
c. a securing mechanism engaged with the leg lock plate of the base and configured to apply pressure to the leg lock plate so as to secure each of the plurality of legs at a desirable angle.

5. The apparatus of claim 4, wherein the lower leg section includes a top body and a bottom body, wherein the leg length adjuster saddle is engaged with the top body.

6. The apparatus of claim 5, wherein the upper leg section includes a plurality of rails arranged to engage with the top body and the bottom body of the lower leg section.

7. The apparatus of claim 1, wherein the base is a clamshell base formed of a top clamshell base and a bottom clamshell base.

8. The apparatus of claim 7, wherein the top clamshell base and the bottom clamshell base are configured to form a bottle opener.

9. An apparatus for securing a component to a monopod, the apparatus comprising:
a monopod flip tip assembly including a cap section, a base section and a tether ring, wherein the cap section is coupled to the base section by the tether ring, wherein the cap section includes a tether ring groove for releasable engagement with the tether ring, and wherein the base section includes a port for engaging with the monopod and a stud for engaging with the component.

10. The apparatus of claim 9, wherein the component may be selected from a camera, a monopod or a multipod.

11. The apparatus of claim 9, further comprising a removable threaded female-to-female adapter.
